(19) United States
(12) Patent Application Publication
(10) Pub. No.: US 2016/0366245 A1
(43) Pub. Date: Dec. 15, 2016

(54) Predictive Collaboration

(71) Applicant: MICROSOFT TECHNOLOGY LICENSING, LLC, Redmond, WA (US)

(72) Inventor: AMIT GUPTA, Redmond, WA (US)

(73) Assignee: MICROSOFT TECHNOLOGY LICENSING, LLC, Redmond, WA (US)

(21) Appl. No.: 15/245,418

(22) Filed: Aug. 24, 2016

Related U.S. Application Data
(63) Continuation of application No. 12/486,753, filed on Jun. 18, 2009.

(51) Int. Cl. H04L 29/08

(52) U.S. Cl. CPC H04L 67/325; H04L 67/141; H04L 67/306; H04L 67/2804

(57) ABSTRACT

Architecture for enabling the definition of candidates of a collaboration session, and the manner or modality of communication that identifies collaboration opportunities, including meeting time, place, and modalities, for example. The modality of communication can include an online meeting, a telephone conference call, or a face-to-face meeting. Meta information of the candidates is aggregated from multiple sources to identify collaboration opportunities and compute an opportunity window for the collaboration session. The meta information can include online presence, availability information, a calendar schedule, geographic location, time zone, expertise, and profile related information. Candidates for the collaboration session can be tagged based on common interest, team membership, or project information. In this way, a predictive model for availability is built for the collaboration session candidates. The candidates are notified of the opportunity window for scheduling of the collaboration session.

### CROSS-REFERENCE TO RELATED APPLICATION

This application is a continuation of, claims the benefit of and priority to previously filed U.S. patent application Ser. No. 12/486,753 filed on Jun. 18, 2009, entitled “PREDICTIVE COLLABORATION”, which is hereby incorporated by reference in its entirety.

### BACKGROUND

In the workplace, coworkers and collaborators schedule meetings to discuss business matters, such as status and strategy for various collaborative projects. In-person, face-to-face meetings offer the advantages of direct, personal interaction among meeting participants. Online meetings can allow participants to share documents on individual computer screens, and are especially useful for meetings among participants in diverse locations.

It can be difficult for collaborators to opportunistically plan meetings with other collaborators on the same project and team. Individual collaborators can be preoccupied with time-sensitive projects, or unavailable due to travel, etc. The greater the number of potential meeting participants, the more difficult it can be to select and schedule mutually agreeable meeting times. Further difficulties and frustrations are encountered if one or more collaborators become unavailable, causing the meeting time to be rescheduled. This can result in delays that impact efficiency and hamper forward progress of a collaborative project.

Typically, collaborators can select and schedule meeting times using conventional means, based on foreseeable opportunities. Computer calendar applications can assist potential meeting participants in selecting common meeting opportunities in the future based on availability information indicated in the calendars. However, comparing calendars can be an iterative, manual process among potential participants. The process is repeated if a meeting is to be rescheduled.

The aforementioned process does not allow the collaborators to identify or select other suitable meeting times, in the event of changes in individual schedules. For example, an earlier meeting opportunity can arise if one or more collaborators become available due to cancellations or other schedule changes. Such opportunities can be lost unless the collaborators manually compare schedules.

Additionally, it can be desirable to invite other meeting participants based on interest or expertise. However, it can be difficult to identify and schedule such individuals unless a person is directly suggested by one of the collaborators. As a result, opportunities for adding value or improving efficiency can be lost.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides predictive collaboration that identifies and selects opportunities for meetings and other collaborative events among potential candidates. The architecture automatically collects and examines various available meta information for collaborators. This meta information can include presence information, calendar information, availability information, location, time zone, expertise of an individual, relationship to other meeting candidates, and any interest tags, for example. The architecture dynamically compares this information to identify potential collaboration opportunities for the collaborators and other meeting candidates.

In addition to meetings, the herein disclosed architecture can provide other tools for predictive collaboration, such as opportunities to connect different people and/or groups working on similar or related projects. This can include an unscheduled ad hoc collaboration and other events. For example, a first user can be working on a new social networking project, and can tag user interest as “social networking” or “people,” for example. A second user creates a social networking event for people to discuss trends of social networking in an enterprise. The architecture can automatically notify the first user of an opportunity to collaborate with the second user during this event.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented collaboration system in accordance with the disclosed architecture.

FIG. 2 illustrates types of preferences used with the collaboration system.

FIG. 3 illustrates an alternative embodiment of a collaboration system that includes additional entities for tagging and aggregation.

FIG. 4 illustrates an alternative embodiment of a collaboration system that includes additional entities for providing information used for prediction.

FIG. 5 illustrates types of meta information provided by a messaging component.

FIG. 6 illustrates types of meta information provided by a realtime communications component.

FIG. 7 illustrates types of meta information provided by a document management component.

FIG. 8 illustrates an alternative embodiment of a collaboration system.

FIG. 9 illustrates types of modalities of communication used with a collaboration system.

FIG. 10 illustrates types of meta information used with the collaboration system.

FIG. 11 illustrates an alternative embodiment of a collaboration system that includes additional entities for identifying and communicating with meeting candidates.

FIG. 12 illustrates an alternative implementation of a collaboration system.

FIG. 13 illustrates a method of identifying and notifying candidates of collaboration opportunities.

FIG. 14 illustrates additional aspects of the method of identifying and notifying candidates of collaboration opportunities.

FIG. 15 illustrates a block diagram of a computing system operable to provide collaboration identification and notification in accordance with the disclosed architecture.

FIG. 16 illustrates an exemplary computing environment operable to provide collaboration identification and notification.

### DETAILED DESCRIPTION

The disclosed architecture enables a user to define candidates of a collaboration session, and the manner or modality of communication in a system that identifies collaboration opportunities, including meeting time, place, and modalities, for example. The modality of communication can include an online meeting, a telephone conference call, or a face-to-face meeting, for example. The modality of communication can also include instant messaging, a group conversation, a topic-based persistent chat room discussion, and an email in which two or more users are connected for collaboration, but not necessarily in realtime, for example.

Meta information of the candidates is aggregated from multiple sources to identify collaboration opportunities and compute an opportunity window for the collaboration session. The meta information can include online presence, availability information, a calendar schedule, geographic location, time zone, expertise, and profile related information. Candidates for the collaboration session can be tagged based on common interests, team membership, or project information, for example. In this way, a predictive model for availability is built for the collaboration session candidates.

The candidates are notified of the opportunity window for scheduling of the collaboration session. The candidates can also be contacted for an ad hoc collaboration or a non-realtime collaboration in which email or a persistent chat room exchange can be used for collaboration and to exchange information, subsequent to a prediction of the possibility of two or more candidates working on a similar interest project.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

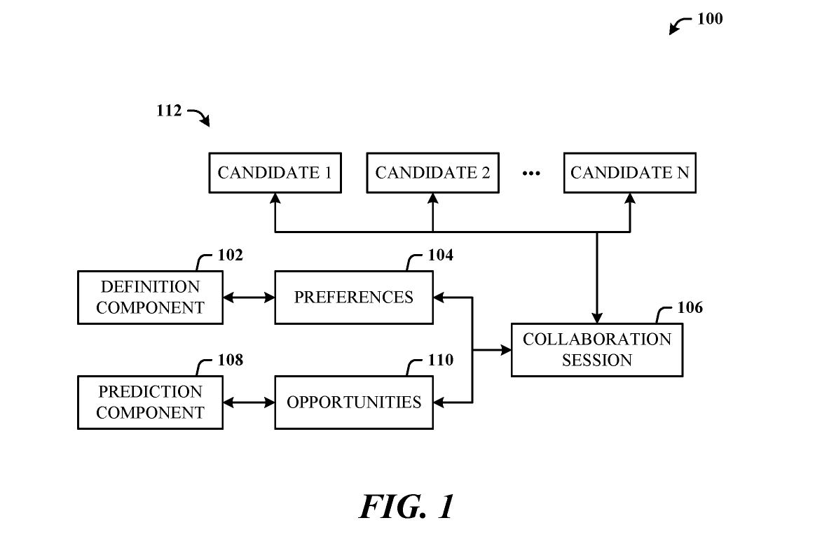

FIG. 1 illustrates a computer-implemented system 100 for identifying and notifying candidates of collaboration opportunities in accordance with the disclosed architecture. A definition component 102 is provided for defining preferences 104 for participation in a collaboration session 106. The preferences 104 can include suitable properties and/or parameters of the collaboration session 106, as described hereinbelow. A prediction component 108 is provided for predicting opportunities 110 to establish the collaboration session 106 in which candidates 112 can participate. The opportunities 110 can include times or situations determined to suitable for the candidates 112. The candidates then become participants in the collaboration session 106. In this manner, the system 100 enables meeting opportunities (e.g., earlier or later) to be presented if one or more of the candidates 112 become available due to cancellations or other schedule changes.

The definition component 102 can also define priorities and thresholds for the candidates 112, indicating a specific number of candidates and/or certain individuals important to the collaboration session 106, so that the collaboration session 106 can go forward in the event that some of the candidates 112 cannot be available to participate.

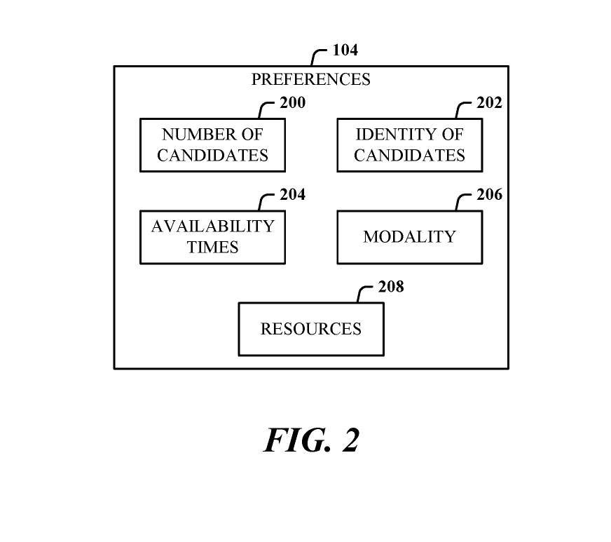

FIG. 2 illustrates the types of preferences 104 that can be used with the collaboration system 100. The preferences 104 can include the number of candidates 200 and the identity 202 of the candidates for the collaboration session. The candidates can be determined explicitly by direct selection or implicitly by inference from other relevant data (as is described in detail hereinbelow). The preferences 104 can also include candidate availability times 204, so that mutually agreeable session times can be determined for the collaboration session.

As illustrated in FIG. 2, the preferences 104 can also include a modality 206 of the collaboration session, where the modality 206 can include a face-to-face (in-person) meeting, a telephone conference call, or an online teleconference (e.g., video), for example. The preferences 104 can also include resources 208 needed for collaboration, such as a physical meeting room.

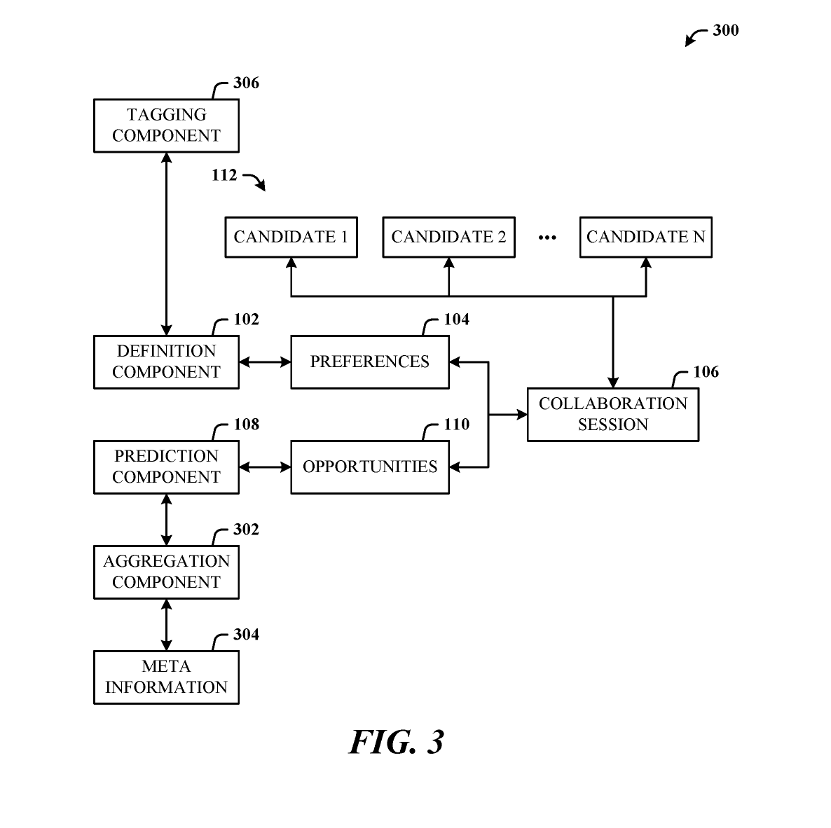

FIG. 3 illustrates an alternative embodiment of a collaboration system that includes additional entities for tagging and aggregation. An aggregation component 302 is provided for aggregating meta information 304 of the candidates 112 to the prediction component 108 to predict the opportunities for the collaboration session 106. The meta information 304 can be aggregated from a variety of sources, including internal network applications and sources available on the Internet, such as the social networking applications, for example. The aggregation component 302 can aggregate meta information 304 about candidates 112 including availability, current or future information indicating free or busy status at specific times, location, time zone, expertise, and other profile related information.

As also illustrated in FIG. 3, the system 300 can include a tagging component 306 for tagging one or more of the candidates 112 defined by the definition component 102. The candidates 112 can be tagged explicitly by name, such as from a contact list, for example. Alternatively, candidates 112 can be identified implicitly on the basis of other factors, including social distance from a collaboration organizer, related team and project information, and expertise or position of the candidates 112 within an enterprise. For example, if a product development meeting requires a technical expert from a different group, the tagging component 306 can tag the individual to be identified, who is invited on this basis. Additionally, the tagging component 306 can identify managers or sales representatives and others not known personally to the organizer of the collaboration session 106. In this way, the tagging component 306 enables the collaboration session 106 to be dynamically organized around a topic and can identify interested or relevant parties for collaboration.

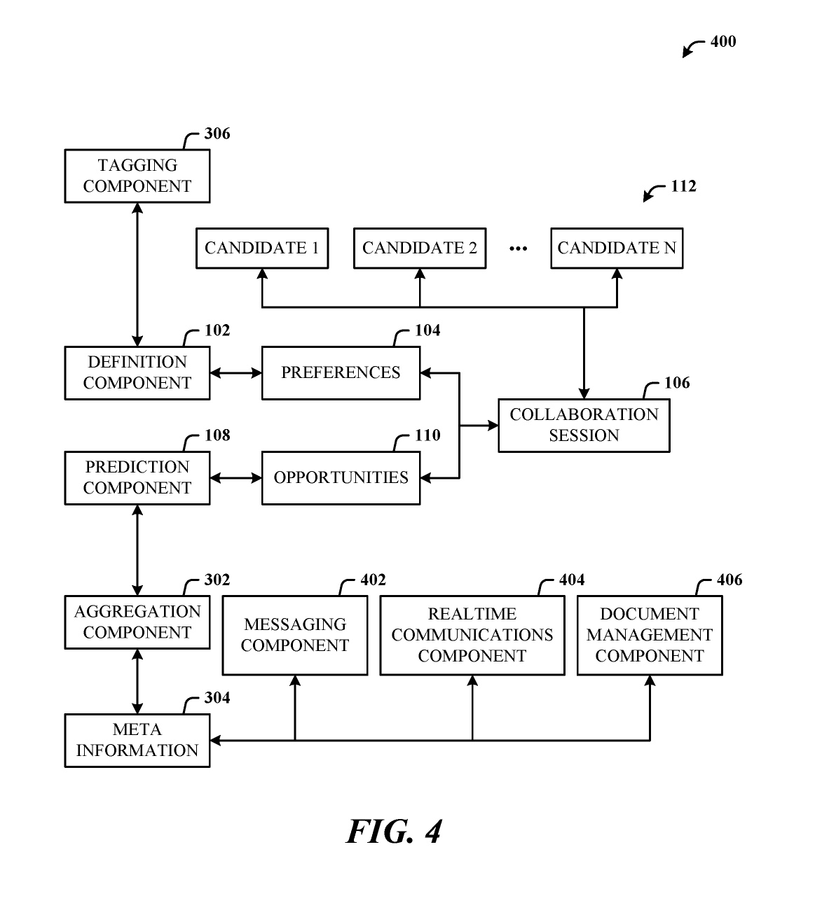

FIG. 4 illustrates an alternative embodiment of a collaboration system that includes additional entities for providing information used for prediction. The aggregation component 302 can receive meta information 304 from a messaging component 402, a realtime communications component 404, and/or a document management component 406. The messaging component 402 can be an email application, for example, that includes personal information management features for providing the meta information 304. The realtime communications component 404 can be a network application, for example, that provides an infrastructure for network communications within an enterprise. The document management component 406 can be an application that enables multiple users to share documents and collaborate on projects in a network environment. The messaging component 402, the realtime communications component 404, and the document management component 406 can all provide meta information 304 to the aggregation component 302 that can be used to identify the opportunities 110 for the collaboration session 106.

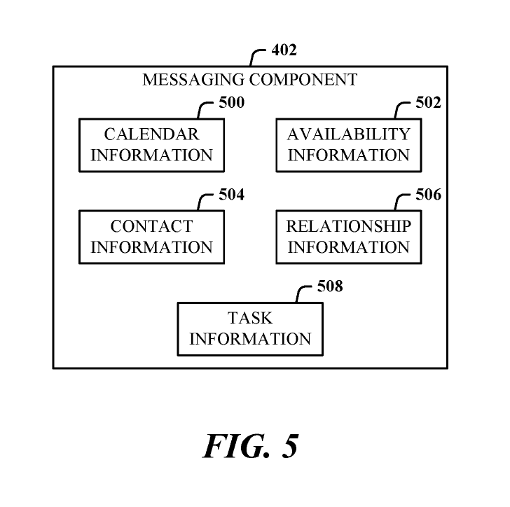

FIG. 5 illustrates types of meta information provided by the messaging component 402 of FIG. 4. The messaging component 402 can include a calendar for providing calendar information 500 and also availability information 502 of the candidates. The messaging component 402 can also include profiles for the candidates and also for others on a contact list, for obtaining contact information 504, such as mail and email addresses, phone numbers, as well as skills and expertise of a contact, for example. Relationship information 506 can obtained, such as a position in the enterprise, and the personal or professional relationship of the candidates to the organizer of the collaboration session 106. The messaging component 402 can also maintain a schedule of task information 508 for the candidates, in order to indicate tasks that require completion by a certain time. As illustrated in FIG. 4, the aggregation component 302 receives the aforementioned inputs from the messaging component 402, which is aggregated as meta information 304 and processed to the prediction component 108 to predict the opportunities 110 for the collaboration session 106.

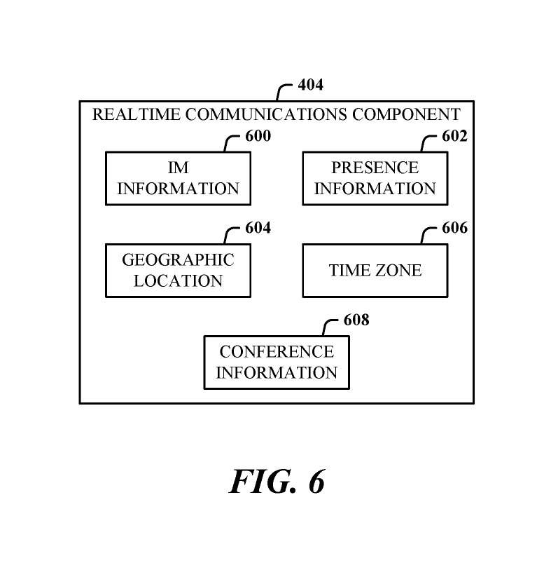

FIG. 6 illustrates types of meta information provided by the realtime communications component 404 of FIG. 4. The realtime communications component 404 can include instant messaging (IM) functionality for providing instant messaging information 600. The realtime communications component 404 can also provide presence information 602, which indicates availability and willingness to communicate on the part of the candidates. The realtime communications component 404 can also include the current and future geographic location 604 and time zone 606 of the candidates. Additionally, conference information 608 of the candidates can indicate current or scheduled conferences in which the candidates are committed. As illustrated in FIG. 4, the aggregation component 302 receives the aforementioned inputs from the realtime communications component 404, which is aggregated as the meta information 304 and processed to the prediction component 108 to predict the opportunities 110 for the collaboration session 106.

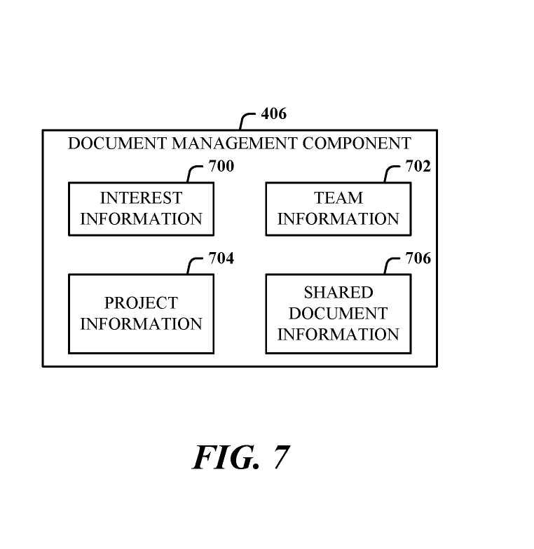

FIG. 7 illustrates types of meta information provided by the document management component 406 of FIG. 4. Interest information 700 can indicate or suggest interest of the candidates based on relevant expertise or involvement in similar or related projects. Team information 702 can identify current collaborators on a project that can be considered for the collaboration session. Project information 704 relates to the specific projects and can identify individuals and keywords that can be cross-referenced to the collaboration session. Shared document information 706 indicates individuals sharing documents and can cross-reference other documents shared among the individuals. As illustrated in FIG. 4, the aggregation component 302 receives the aforementioned inputs from the document management component 406, which is aggregated as the meta information 304 and processed to the prediction component 108 to predict the opportunities 110 for the collaboration session 106.

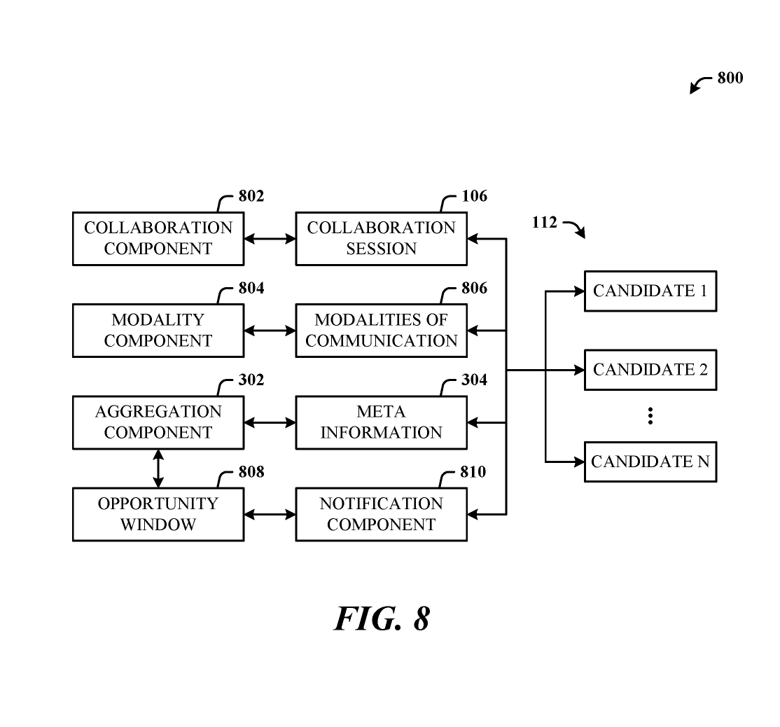

FIG. 8 illustrates an alternative embodiment of a collaboration system 800. A collaboration component 802 is provided for defining the candidates 112 of the collaboration session 106. In this manner, an organizer of the collaboration session 106 can select candidates 112 deemed suitable for participation in the collaboration session 106. A modality component 804 defines modalities of communication 806 between the candidates 112. The aggregation component 302 provides for aggregating the meta information 304 of the candidates 112 from multiple sources to compute an opportunity window 808 for the collaboration session 106.

As also illustrated in FIG. 8, a notification component 810 notifies the candidates 112 of the opportunity window 808 and possible opportunities for collaboration. It is to be appreciated that multiple opportunity windows 808 can be computed, to provide latitude and flexibility to the organizer in planning a collaboration session 106. The session organizer can act on the notification and either start a real time communication or schedule a meeting for a future opportunity window 808.

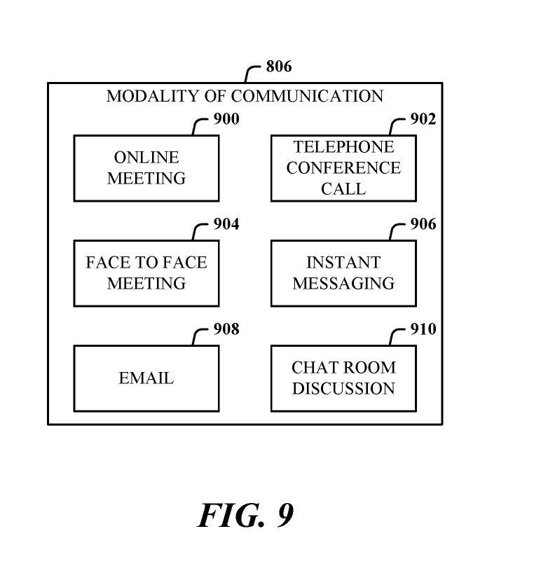

FIG. 9 illustrates types of the modalities of communication 806 employed by the collaboration system 800. The modalities of communication 806 can include an online meeting 900 in which participants engage in the collaboration session via computers. The participants can be in diverse locations and can view a common presentation over computers. The modalities of communication 806 can also include a telephone conference call 902 in which participants in diverse locations can speak over telephone connections to the session. The modalities of communication 806 can also include a conventional face-to-face meeting 904 where participants gather in a conference room or other dedicated space for in-person interaction.

As illustrated in FIG. 9, the modalities of communication 806 can also include instant messaging 906. The modalities of communication 806 can also include email 908 in which two or more users are connected for collaboration, but not necessarily in realtime. The modalities of communication 806 can also include a topic-based persistent group chat room discussion 910, for example.

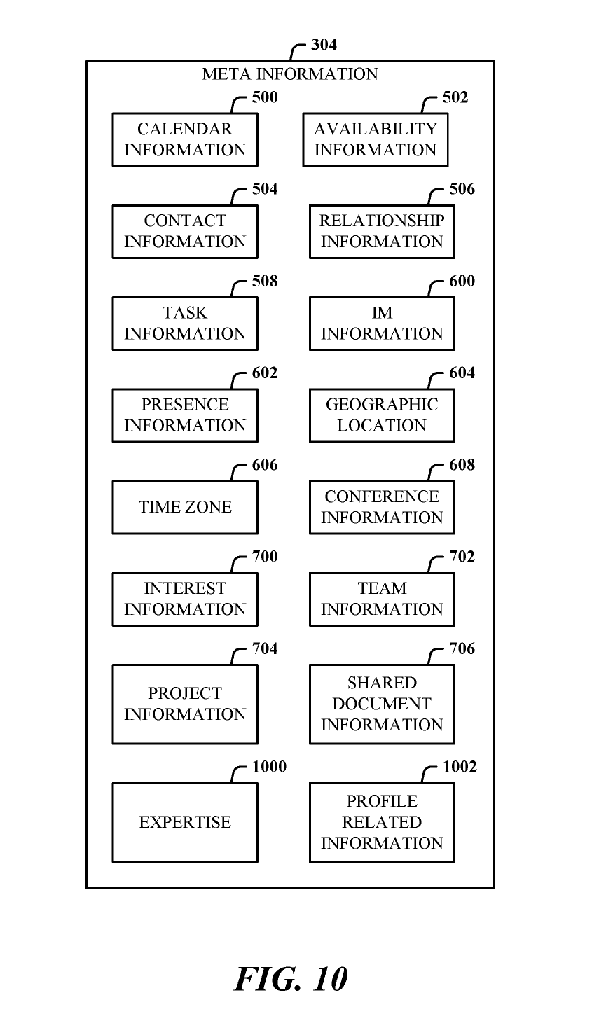

FIG. 10 illustrates types of meta information 304 that can be used with the collaboration system 800 of FIG. 8. The meta information 304 can include the meta information illustrated in FIGS. 5-7 hereinabove, including calendar information 500, availability information 502, contact information 504, relationship information 506, task information 508, instant messaging information 600, presence information 602, geographic location 604, time zone 606, conference information 608, interest information 700, team information 702, project information 704, and shared document information 706.

The aforementioned types of meta information 304 can be obtained from different sources, not limited to the components indicated in FIGS. 5-7. Additionally, the meta information 304 can include information from other sources, such as social networking applications. The meta information 304 can include expertise 1000 of the candidates and profile related information 1002.

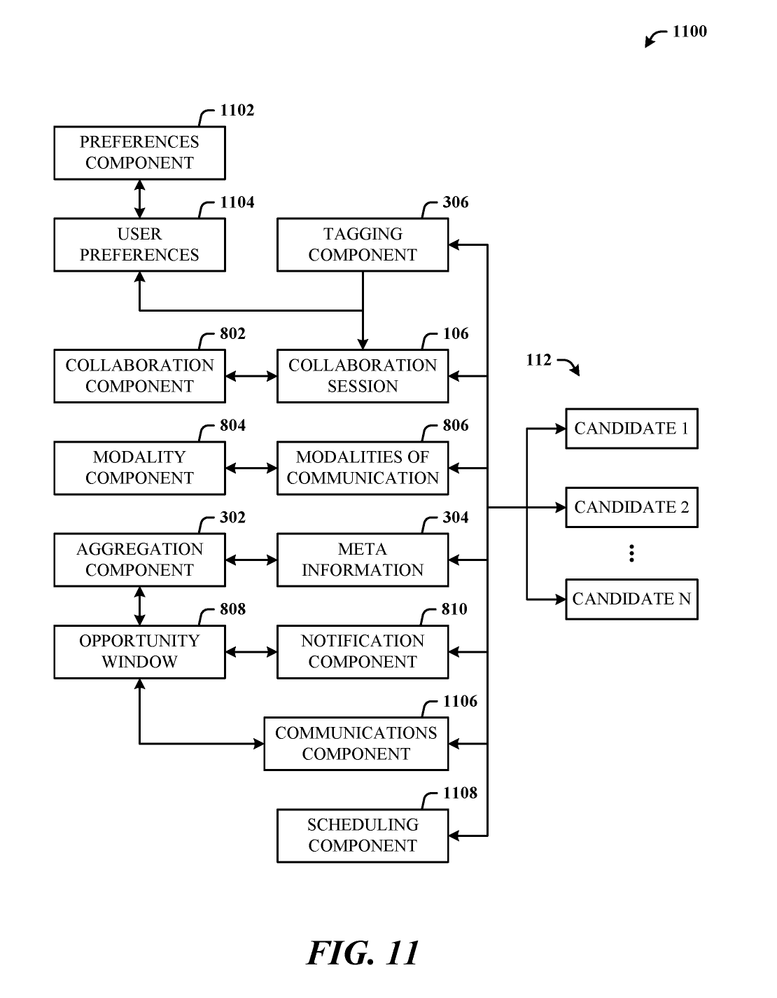

FIG. 11 illustrates an alternative embodiment of a collaboration system 1100 that includes additional entities for identifying and communicating with meeting candidates. A preferences component 1102 defines user preferences 1104 of the collaboration session 106. The user preferences 1104 can include aspects, properties, and/or parameters of the collaboration session 106, such as who can participate (e.g., the candidates 112), what are the topics for the session 106, when the session 106 can occur (including proposed times for opportunity window 808), and how the session 106 will take place (e.g., the modalities of communication 806).

As also illustrated in FIG. 11, the tagging component 306 can be used for recommending the candidates 112 for the collaboration session 106 based on common interests, team membership, or project information. In this manner, it is possible to identify candidates 112 having relevance to the session 106, outside of anyone specifically invited by the organizer. A communications component 1106 is provided for conducting the collaboration session 106 based on the opportunity window 808. The communications component 1106 can include an online communications component for online meetings, a telephone conferencing system, or a video conferencing system, for example.

As also illustrated in FIG. 11, a scheduling component 1108 is provided for scheduling the collaboration session 106 based on the opportunity window 808. Upon identifying one or more suitable opportunity windows, the scheduling component 1108 can automatically schedule a meeting for a future opportunity window 808. This can be accomplished by recording the collaboration session 106 as a calendar or task item in a messaging application of the candidates 112. The scheduling component 1108 can also send reminder alerts via email, instant messaging, etc.

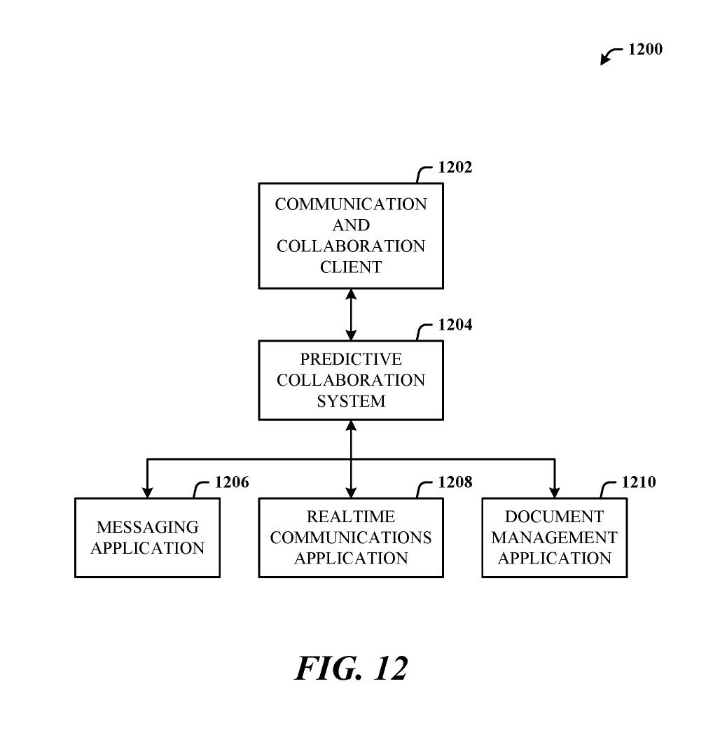

FIG. 12 illustrates an alternative implementation of a collaboration system 1200. A communication and collaboration client 1202 is employed to define user preferences and tag individuals for participation in a collaboration session. The user preferences can include defining a list of individuals for collaboration and also defining one or more modalities for communication (e.g., an online meeting, a face-to-face meeting, a telephone conference, etc.). Tagging can include recommending participants based on interest, team membership and relevant project information, to name just a few examples.

As also illustrated in FIG. 12, the collaboration system 1200 also includes a predictive collaboration system 1204 for aggregating information from various sources, and predictively computing an opportunity window for collaboration among the participants. The predictive collaboration system 1204 aggregates meta information such as presence, calendar information, geographic location, etc. The predictive collaboration system 1204 can be a software application or module running on a client device or a network system in which information sources are accessible.

As also illustrated in FIG. 12, information sources can include a messaging application 1206 such as an email and personal information management (PIM) application that provide various types of meta information. A realtime communications application 1208 can be a network communications application providing various communications services within an enterprise. A document management application 1210 can be a network application that enables multiple users to share documents and collaborate on projects. Each or any combination thereof of these information sources can be used by the predictive collaboration system 1204 to aggregate and process meta information to compute one or more opportunity windows for collaborative interaction.

Predictive collaboration in accordance with the herein disclosed embodiments enables a collaboration organizer a simple and easy approach to find and connect with other individuals, thereby enhancing productivity and saving time for information workers. The disclosed embodiments obtain and process meta information of individuals such as availability, free times and busy times, location, time zone, expertise and other profile related information, etc. While employing meta information, it can still take several attempts to find suitable opportunities to collaborate with the individuals. The disclosed embodiments simplify the experience of connecting and collaborating with others in a common social or professional network.

Scenarios follow herewith that describe solutions available through the herein disclosed embodiments. Consider that USER1 seeks to meet with USER2 and USER3, and uses the disclosed architecture to proactively compute a meeting opportunity. The architecture uses calendar data and realtime availability data to identify and suggest the next available window of opportunity for both USER 2 and USER3. Manually scheduling a collaboration session using the calendar represents a static snapshot of a point in time. Instead, the architecture dynamically looks for upcoming slots of availability, and accounts for schedule changes on the calendars of both USER2 and USER 3.

In another scenario, USER1 desires to discuss information with USER2 and looks for an opportunity to meet online. Using the presences state of both USER1 and USER2, the architecture computes when both USER1 and USER2 are available online In a still further scenario, the architecture can use location information to notify USER1 if USER2 is available in the office for a face-to-face meeting. The location information can include a login on an office machine, presence status, and/or geographic location, etc.

In an additional scenario, USER1 is working on a media project with collaborators located in different locations. USER1 has not planned a meeting but knows the collaborators are planning to be in town. USER1 uses the system to find a window of opportunity for a face-to-face meeting while the collaborators are in town. The architecture watches for availability, location, calendar, and other information for USER1 and the other team members, and suggests one or more windows of opportunity for the meeting.

In yet another scenario, USER1 likes to keep connected to a business network. The architecture gives USER1 recommendations on possible lunch meetings with individuals based on mutual availability. The aforementioned scenarios are presented by way of example. Other scenarios can be contemplated without departing from the disclosed embodiments.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

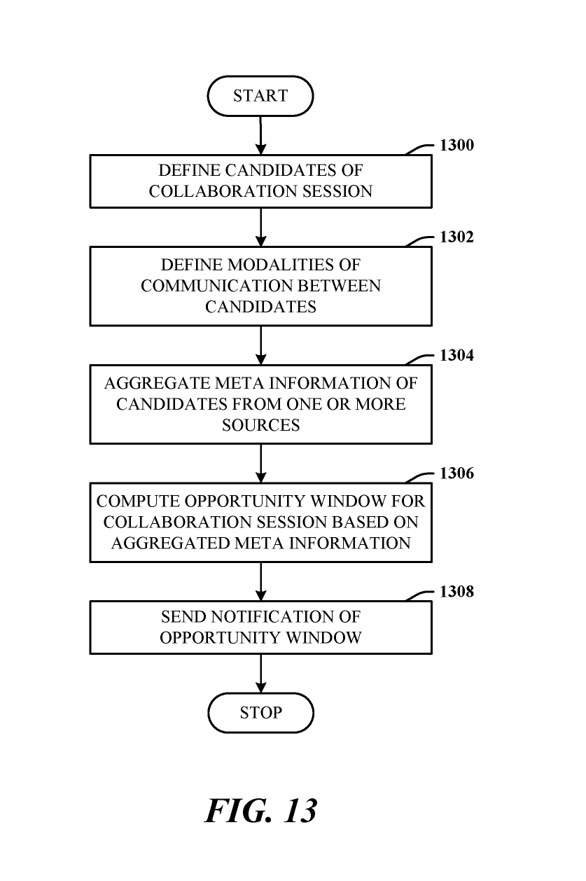

FIG. 13 illustrates a method of identifying and notifying candidates of collaboration opportunities. At 1300, candidates of a collaboration session are defined. At 1302, a modality of communication between the candidates is defined. At 1304, meta information of the candidates is aggregated from one or more sources. At 1306, an opportunity window for the collaboration session is computed based on the aggregated meta information. One or more opportunity windows can also be computed. At 1308, a notification is sent of the opportunity window.

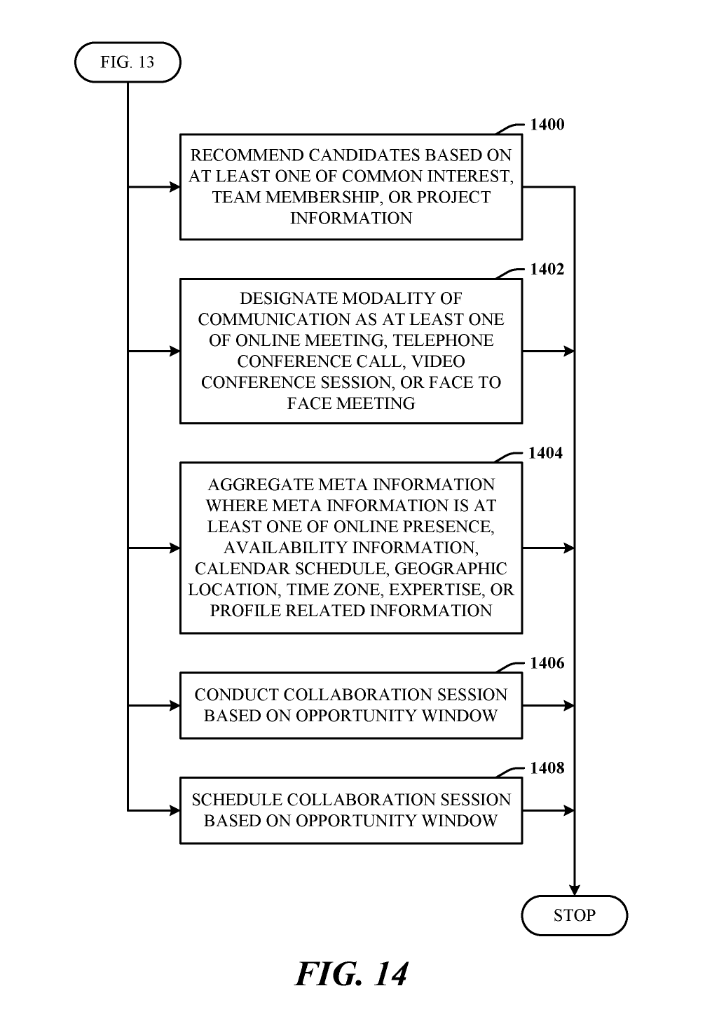

FIG. 14 illustrates additional aspects of the method of identifying and notifying candidates of collaboration opportunities. At 1400, the candidates are recommended based on at least one of common interest, team membership, or project information. At 1402, the modality of communication is designated as at least one of an online meeting, a telephone conference call, a video conference session, or a face-to-face meeting. At 1404, the meta information is aggregated, where the meta information is at least one of online presence, availability information, a calendar schedule, geographic location, time zone, expertise, or profile related information. Other types of meta information can be also included. At 1406, the collaboration session is conducted based on the opportunity window. At 1408, the collaboration session is scheduled based on the opportunity window.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

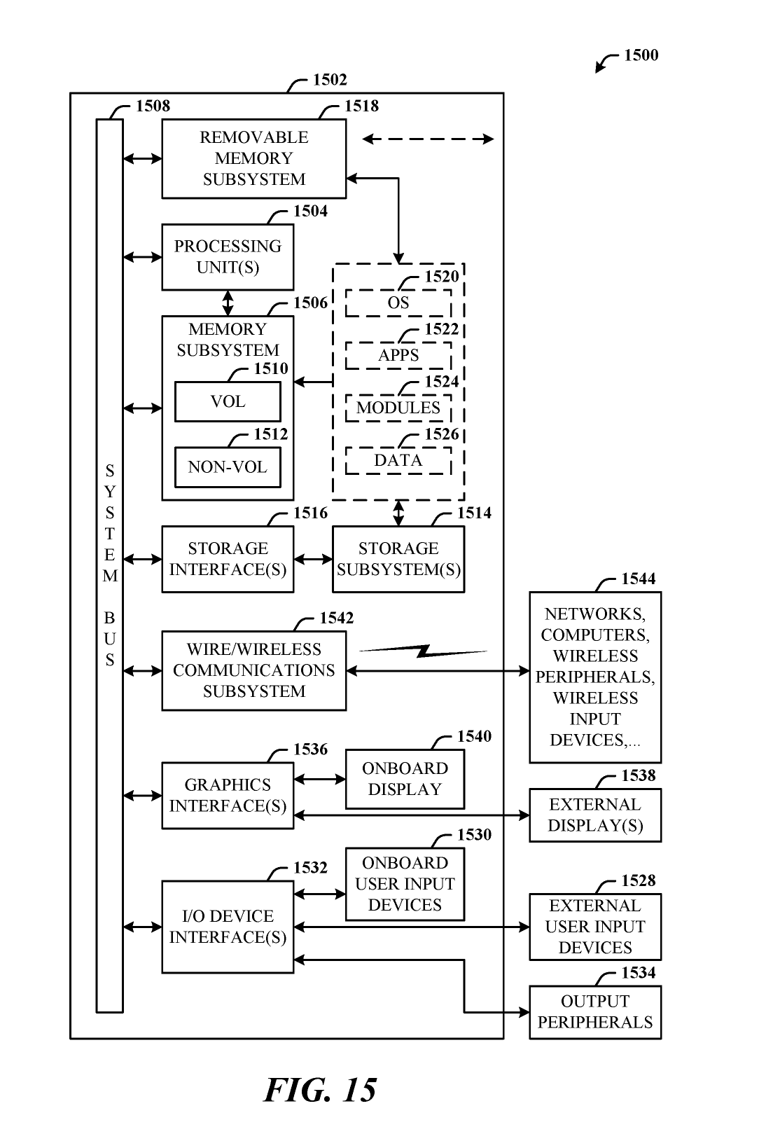

Referring now to FIG. 15, there is illustrated a block diagram of a computing system 1500 operable to execute identification and notification to candidates of collaboration opportunities in accordance with the disclosed architecture. In order to provide additional context for various aspects thereof, FIG. 15 and the following discussion are intended to provide a brief, general description of the suitable computing system 1500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1500 for implementing various aspects includes the computer 1502 having processing unit(s) 1504, a system memory 1506, and a system bus 1508. The processing unit(s) 1504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1506 can include volatile (VOL) memory 1510 (e.g., random access memory (RAM)) and non-volatile memory (NON-VOL) 1512 (e.g., ROM, EPROM, EEPROM, etc.). A basic input/output system (BIOS) can be stored in the non-volatile memory 1512, and includes the basic routines that facilitate the communication of data and signals between components within the computer 1502, such as during startup. The volatile memory 1510 can also include a high-speed RAM such as static RAM for caching data.

The system bus 1508 provides an interface for system components including, but not limited to, the memory subsystem 1506 to the processing unit(s) 1504. The system bus 1508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1502 further includes storage subsystem(s) 1514 and storage interface(s) 1516 for interfacing the storage subsystem(s) 1514 to the system bus 1508 and other desired computer components. The storage subsystem(s) 1514 can include one or more of a hard disk drive (HDD), a magnetic floppy disk drive (FDD), and/or optical disk storage drive (e.g., a CD-ROM drive DVD drive), for example. The storage interface(s) 1516 can include interface technologies such as EIDE, ATA, SATA, and IEEE 1394, for example.

One or more programs and data can be stored in the memory subsystem 1506, a removable memory subsystem 1518 (e.g., flash drive form factor technology), and/or the storage subsystem(s) 1514 (e.g., optical, magnetic, solid state), including an operating system 1520, one or more application programs 1522, other program modules 1524, and program data 1526.

Generally, programs include routines, methods, data structures, other software components, etc., that perform particular tasks or implement particular abstract data types. All or portions of the operating system 1520, applications 1522, modules 1524, and/or data 1526 can also be cached in memory such as the volatile memory 1510, for example. It is to be appreciated that the disclosed architecture can be implemented with various commercially available operating systems or combinations of operating systems (e.g., as virtual machines).

The aforementioned application programs 1522, program modules 1524, and program data 1526 can include the computer-implemented system 100, the definition component 102, the preferences 104, the collaboration session 106, the prediction component 108, the opportunities 110, and the candidates 112 of FIG. 1, the number of candidates 200, the identity of the candidates 202, the candidate availability times 204, the modality 206, and the resources 208 of FIG. 2, the system 300 including additional components such as the aggregation component 302, the meta information 304, and the tagging component 306 of FIG. 3, the system 400 including additional components such as the messaging component 402, the realtime communications component 404, and the document management component 406 of FIG. 4, the calendar information 500, the availability information 502, the contact information 504, and the relationship information 506 of FIG. 5, the instant messaging information 600, the presence information 602, the geographic location 604, the time zone 606, and the conference information 608 of FIG. 6 and, the interest information 700, the team information 702, the project information 704, and the shared document information 706 of FIG. 7.

The aforementioned application programs 1522, program modules 1524, and program data 1526 can further include the system 800, which comprises additional components such as the collaboration component 802, the modality component 804, the modalities of communication 806, the opportunity window 808, and the notification component 810 of FIG. 8, the online meeting 900, the telephone conference call 902, the face-to-face meeting 904, the instant messaging exchange 906, the email exchange 908, and the persistent group chat room discussion 910 of FIG. 9, the additional meta information 304 in the form of expertise 1000 and the profile related information 1002 FIG. 10, the system 1100 and additional components such as the preference component 1102, the user preferences 1104, the communication component 1106, and the scheduling component 1108 of FIG. 11, the system 1200 and components, including the communication and collaboration client 1202, the predictive collaboration system 1204, the messaging application 1206, the realtime communications application 1208, and the document management application 1210 of FIG. 12, and the methods of FIGS. 13-14, for example.

The storage subsystem(s) 1514 and memory subsystems (1506 and 1518) serve as computer readable media for volatile and non-volatile storage of data, data structures, computer-executable instructions, and so forth. Computer readable media can be any available media that can be accessed by the computer 1502 and includes volatile and non-volatile media, removable and non-removable media. For the computer 1502, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1502, programs, and data using external user input devices 1528 such as a keyboard and a mouse. Other external user input devices 1528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1502, programs, and data using onboard user input devices 1530 such a touchpad, microphone, keyboard, etc., where the computer 1502 is a portable computer, for example. These and other input devices are connected to the processing unit(s) 1504 through input/output (I/O) device interface(s) 1532 via the system bus 1508, but can be connected by other interfaces such as a parallel port, IEEE 1394 serial port, a game port, a USB port, an IR interface, etc. The I/O device interface(s) 1532 also facilitate the use of output peripherals 1534 such as printers, audio devices, camera devices, and so on, such as a sound card and/or onboard audio processing capability.

One or more graphics interface(s) 1536 (also commonly referred to as a graphics processing unit (GPU)) provide graphics and video signals between the computer 1502 and external display(s) 1538 (e.g., LCD, plasma) and/or onboard displays 1540 (e.g., for portable computer). The graphics interface(s) 1536 can also be manufactured as part of the computer system board.

The computer 1502 can operate in a networked environment (e.g., IP) using logical connections via a wired/wireless communications subsystem 1542 to one or more networks and/or other computers. The other computers can include workstations, servers, routers, personal computers, microprocessor-based entertainment appliance, a peer device or other common network node, and typically include many or all of the elements described relative to the computer 1502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1502 connects to the network via a wired/wireless communication subsystem 1542 (e.g., a network interface adapter, onboard transceiver subsystem, etc.) to communicate with wired/wireless networks, wired/wireless printers, wired/wireless input devices 1544, and so on. The computer 1502 can include a modem or has other means for establishing communications over the network. In a networked environment, programs and data relative to the computer 1502 can be stored in the remote memory/storage device, as is associated with a distributed system. It will be appreciated that the network connections shown are exemplary and other means of establishing a communications link between the computers can be used.

The computer 1502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

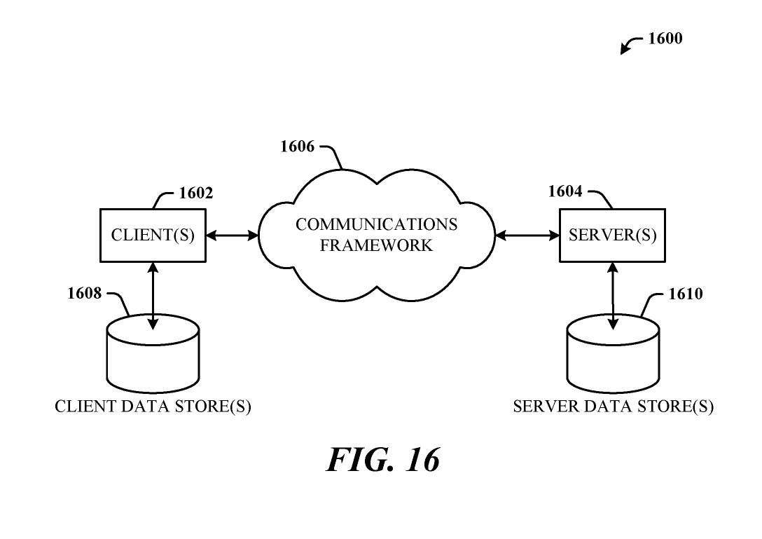

Referring now to FIG. 16, there is illustrated a schematic block diagram of a computing environment 1600 that can be used for identification and notification to candidates of collaboration opportunities. The environment 1600 includes one or more client(s) 1602. The client(s) 1602 can be hardware and/or software (e.g., threads, processes, computing devices). The client(s) 1602 can house cookie(s) and/or associated contextual information, for example.

The environment 1600 also includes one or more server(s) 1604. The server(s) 1604 can also be hardware and/or software (e.g., threads, processes, computing devices). The servers 1604 can house threads to perform transformations by employing the architecture, for example. One possible communication between a client 1602 and a server 1604 can be in the form of a data packet adapted to be transmitted between two or more computer processes. The data packet may include a cookie and/or associated contextual information, for example. The environment 1600 includes a communication framework 1606 (e.g., a global communication network such as the Internet) that can be employed to facilitate communications between the client(s) 1602 and the server(s) 1604.

Communications can be facilitated via a wire (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus, comprising:
a collaboration component to select candidates of a collaboration session;
an aggregation component to aggregate meta information of the candidates, the meta information to include at least calendar information;
a prediction component to compute one or more opportunity windows for the collaboration session based on the aggregated meta information of the candidates; and
a hardware microprocessor configured to execute computer-executable instructions in a memory, the instructions executed to enable at least one of the collaboration component, the aggregation component, or the prediction component.

2. The apparatus of claim 1, comprising a scheduling component to schedule the collaboration session for an opportunity window.

3. The apparatus of claim 1, comprising a notification component to notify the candidates of the scheduled collaboration session.

4. The apparatus of claim 1, comprising the prediction component to compute multiple opportunity windows for the collaboration session.

5. The apparatus of claim 4, comprising a notification component to notify a candidate of the multiple opportunity windows.

6. The apparatus of claim 5, comprising a scheduling component to receive a selection of one of the multiple opportunity windows, and schedule the collaboration session for the selected opportunity window.

7. The apparatus of claim 1, wherein the meta information comprises at least one of availability information, contact information, relationship information, task information, instant messaging information, presence information, geographic location, time zone, conference information, interest information, team information, project information, shared document information, expertise, or profile related information.

8. A method, comprising:
selecting candidates of a collaboration session;
aggregating meta information of the candidates, the meta information to include at least calendar information; and
computing one or more opportunity windows for the collaboration session based on the aggregated meta information of the candidates.

9. The method of claim 8, comprising scheduling the collaboration session for an opportunity window.

10. The method of claim 8, comprising notifying the candidates of the scheduled collaboration session.

11. The method of claim 8, comprising computing multiple opportunity windows for the collaboration session.

12. The method of claim 11, comprising notifying a candidate of the multiple opportunity windows.

13. The method of claim 12, comprising receiving a selection of one of the multiple opportunity windows.

14. The method of claim 13, comprising scheduling the collaboration session for the selected opportunity window.

15. The method of claim 8, wherein the meta information comprises at least one of availability information, contact information, relationship information, task information, instant messaging information, presence information, geographic location, time zone, conference information, interest information, team information, project information, shared document information, expertise, or profile related information.

16. At least one computer-readable storage medium comprising instructions that, when executed, cause a system to:
select candidates of a collaboration session;
aggregate meta information of the candidates, the meta information to include at least calendar information; and
compute one or more opportunity windows for the collaboration session based on the aggregated meta information of the candidates.

17. The computer-readable storage medium of claim 16, comprising further instructions that, when executed, cause a system to schedule the collaboration session for an opportunity window.

18. The computer-readable storage medium of claim 16, comprising further instructions that, when executed, cause a system to notify the candidates of the scheduled collaboration session.

19. The computer-readable storage medium of claim 16, comprising further instructions that, when executed, cause a system to:
compute multiple opportunity windows for the collaboration session;
notify a candidate of the multiple opportunity windows;
receive a selection of one of the multiple opportunity windows; and
schedule the collaboration session for the selected opportunity window.

20. The computer-readable storage medium of claim 16, wherein the meta information comprises at least one of availability information, contact information, relationship information, task information, instant messaging information, presence information, geographic location, time zone, conference information, interest information, team information, project information, shared document information, expertise, or profile related information.
